(19) United States
(12) Patent Application Publication
(10) Pub. No.: US 2021/0131807 A1
(43) Pub. Date: May 6, 2021

(54) FREE-FORM ROUTE GENERATION

(71) Applicant: International Business Machines Corporation, Armonk, NY (US)

(72) Inventors: Hyman Chantz, Scarsdale, NY (US); Cesar Augusto Rodriguez Bravo, Alajuela (CR); Romelia H. Flores, Keller, TX (US); María Laura Alpízar Barrera, Alajuela (CR)

(21) Appl. No.: 16/670,242

(22) Filed: Oct. 31, 2019

(51) Int. Cl. G01C 21/20; H04L 29/08; G06F 3/14

(52) U.S. Cl. CPC G01C 21/20; G06F 3/14; H04L 67/12

(57) ABSTRACT

One example of a computer-implemented method comprises receiving data from one or more sensors distributed throughout a geographic area; receiving one or more user preferences related to the geographic area; and generating one or more free-form routes from a first location to a second location based on analysis of the received data with respect to the one or more user preferences such that each of the one or more free-form routes complies with the one or more user preferences. Each of the one or more free-form routes includes at least a segment which does not follow a pre-defined path. The method also comprises outputting at least one of the one or more free-form routes to a display system on a first user device.

### BACKGROUND

Conventional mapping systems rely on predefined roads, paths, etc. on maps in order to plan a route from a starting location to a destination location. Additionally, such systems are typically two-dimensional systems.

### SUMMARY

Aspects of the disclosure may include a computer-implemented method, computer program product, and system. One example of the computer-implemented method comprises receiving data from one or more sensors distributed throughout a geographic area; receiving one or more user preferences related to the geographic area; and generating one or more free-form routes from a first location to a second location based on analysis of the received data with respect to the one or more user preferences such that each of the one or more free-form routes complies with the one or more user preferences. Each of the one or more free-form routes includes at least a segment which does not follow a pre-defined path. The method also comprises outputting at least one of the one or more free-form routes to a display system on a first user device.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a high-level block diagram of one embodiment of an example free-form route generation system.

FIG. 2 is a high-level depiction of one embodiment of example sensors distributed in an example geographic area.

FIG. 3 is a high-level depiction of one embodiment of example free-form routes in an example geographic area.

FIG. 4 is a high-level depiction of another embodiment of example free-form routes in an example geographic area.

FIG. 5 depicts a high-level block diagram of one embodiment of an example user device 500 configured to implement a free-form route generator.

FIG. 6 is a flow chart depicting one embodiment of an example method of generating a free-form route.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

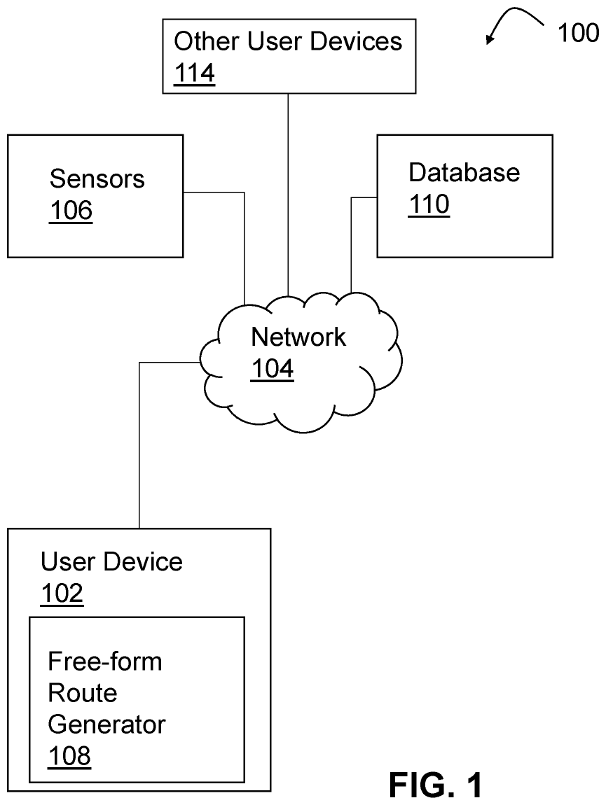

FIG. 1 is a high-level block diagram of one embodiment of a free-form route generation system 100. The system 100 includes a user device 102 communicatively coupled to one or more sensors 106, and a database 110 via a network 104.

Network 104 can be implemented using any number of any suitable physical and/or logical communications topologies. Network 104 can include one or more private or public computing networks. For example, network 104 may comprise a private network (e.g., a network with a firewall that blocks non-authorized external access) that is associated with the workload. Alternatively, or additionally, network 104 may comprise a public network, such as the Internet. Thus, network 104 may form part of a packet-based network, such as a local area network, a wide-area network, and/or a global network such as the Internet. Network 104 can include one or more servers, networks, or databases, and can use one or more communication protocols to transfer data between user device 102, sensors 106, database 110, and other user devices 114. Furthermore, although illustrated in FIG. 1 as a single entity, in other examples network 104 may comprise a plurality of networks, such as a combination of public and/or private networks. The communications network 104 can include a variety of types of physical communication channels or “links.” The links can be wired, wireless, optical, and/or any other suitable media. In addition, the communications network 104 can include a variety of network hardware and software for performing routing, switching, and other functions, such as routers, switches, base stations, bridges or any other equipment that may be useful to facilitate communicating data.

Furthermore, it is to be understood that although sensors 106, database 110, and other user devices 114 are depicted in the example of FIG. 1 as being communicatively coupled to the user device 102 via the same network 104, for purposes of illustration, sensors 106, database 110, and other user devices 114 can be coupled to the user device 102 via separate networks, in other embodiments. For example, in some embodiments, database 110 can be communicatively coupled to the user device 102 via a cellular network or a wide area network while the other user devices 114 are communicatively coupled to the user device 102 via a short-range wireless network, such as, but not limited to, Bluetooth® technology developed and maintained by Bluetooth SIG, Inc.

The user device 102 includes free-form route generator 108. The free-form route generator 108 is configured to dynamically generate a route from an origination point to a destination point based on user preferences and on data received from one or more of sensors 106, database 110, and other user devices 114. In particular, as described in more detail below, the free-form route generator 108 is configured to generate routes that are not confined to pre-established or mapped paths, roads, etc. For example, conventional mapping applications identify routes using only pre-established roads, walking paths, bus routes, etc. that are part of a map of such pre-defined roads, walking paths, bus routes, etc. In contrast, through the use of user preferences and the data collected from one or more of sensors 106, database 110, and other user devices 114, the free-form route generator 108 is able to generate a route that can include sections traversing unmapped paths, such as a route section which traverses a forest, open field, etc. that does not include a pre-defined path. Thus, the routes generated by free-form route generator 108 can be referred to herein as free-form routes in that they are not required to follow specific, pre-defined roads, paths, etc. on a map of such pre-defined paths. As used herein, a pre-defined path refers to a road, walkway, path, train route, bus route, subway route, etc. that is defined on a map. As used herein, the term free-form route refers to a route in which at least a segment of the route is not part of a pre-defined path.

To aid in enabling the free-form route generator 108 to generate the free-form routes, the user device 102 obtains data from one or more sensors 106. For example, the one or more sensors 106 can include, but are not limited to, a light sensor configured to capture data regarding the level of luminosity of a given area, an ultraviolet (UV) sensor configured to capture data regarding a UV level of a given area, a water sensor configured to detect the presence of water in an environment (e.g. such as due to rain, snow, etc.), a camera configured to capture images of a given area (e.g. to provide images to the user to confirm a given condition such as rain), a heat sensor configured to measure heat of a given location (e.g. such as to detect solar exposure, thermal sensation, etc.), a gas sensor to detect levels of specific types of gases in an area, a laser sensor configured to measure the distance between objects, an ultrasonic sensor configured to measure the distance between objects, an altimeter to measure altitude, a gyroscope (e.g. to measure movement changes indicative of changes in terrain), a barometer, a humidity sensor configured to measure humidity levels of a given area, and a compass or other indicator of magnetic field which can be used, for example, for navigation and/or measuring magnetic field variability in geology.

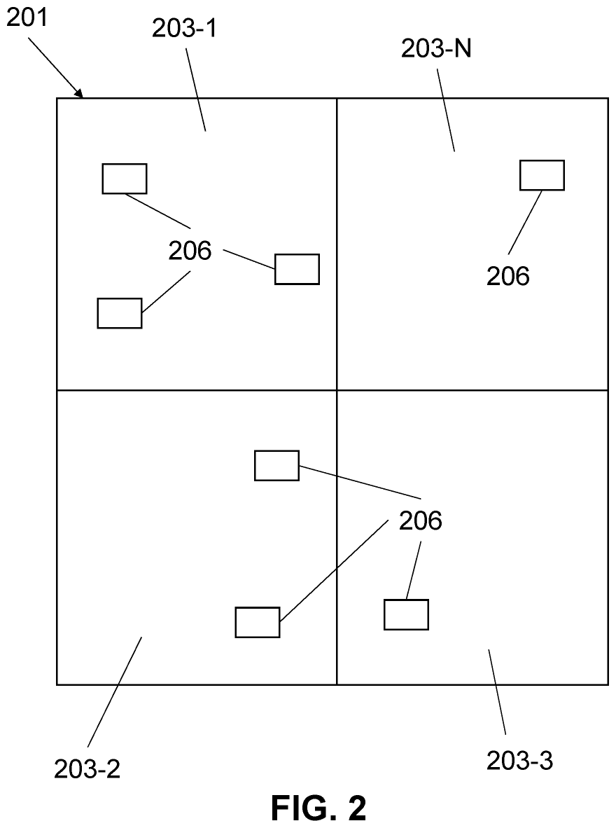

The sensors 106 are configured to collect data throughout a geographic area, such as geographic area 201 in FIG. 2 which depicts a plurality of sensors 206 in the geographic area 201. For example, in some embodiments, one or more of the sensors 206 can be located at fixed locations to collect data, such as weather conditions, UV measurements, ambient light measurements, etc. Additionally, in some embodiments, one or more of the sensors 206 can be configured to move throughout the geographic area 201 and collect data at different positions. For example, in some embodiments, one or more of the sensors are located on an unmanned aerial vehicle (UAV) or an unmanned ground vehicle (UGV) and configured to collect data as the unmanned vehicle travels throughout the geographic area 201. Furthermore, in some embodiments, one or more of the sensors 206 are sensors in one or more other user devices 114. Sensors located on one or more other user devices 114 can collect data as the individual carrying the other user device 114 traverses portions of the geographic area 201. For example, the device of a user hiking through an area can collect data regarding weather conditions, terrain conditions, light conditions, etc. Thus, in some embodiments, at least a portion of the data regarding the geographic area 201 is collected through crowdsourced data from the one or more other user devices 114.

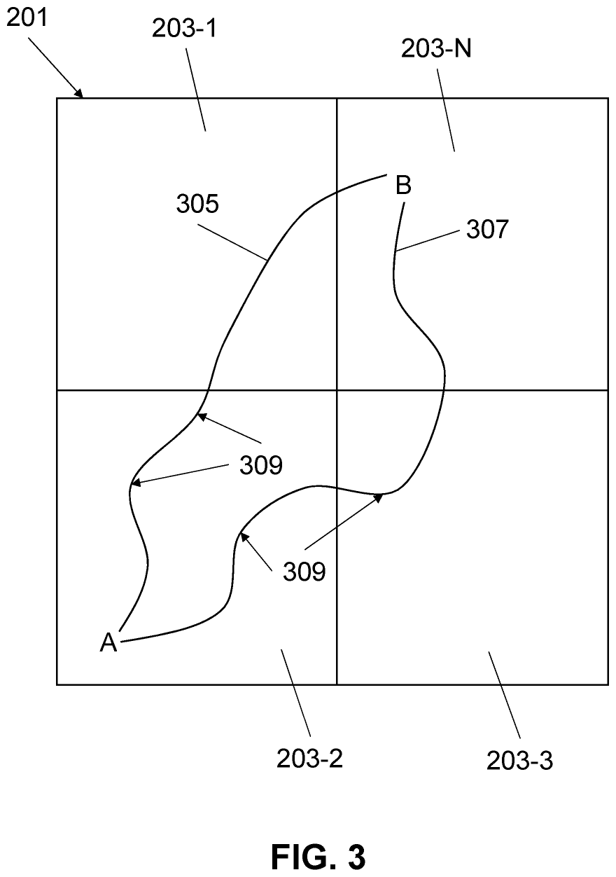

Based on the data collected by the sensors 106/206, the free-form route generator 108 of user device 102 generates a free-form route from a starting location to an end location in accordance with user-defined preferences. For example, a user can set a preference to avoid terrain that has an incline or slope greater than a user defined value. Thus, based on various data points for terrain throughout area 201, such as, for example, from altimeters and gyroscopes, the free-form route generator 108 can calculate slope of terrain at various points to generate a free-form route that does not include a segment of terrain with a slope that is greater than the user defined value. For example, as shown in FIG. 3, the free-form route generator 108 can calculate direction changes 309 based on the slope of terrain at points of area 201 corresponding to the direction changes 309 in order to avoid terrain that has a slope greater than the user defined value. In another example, a user can set a preference for avoiding areas with a UV exposure level above a user defined value. In yet another example, a user can set a preference for using areas that have an ambient light level above a user defined value. It is to be understood that other user preferences can be used, in other embodiments, that correspond to the type of data collected from sensors 106. Thus, based on the user defined preferences and the data collected by the sensors 106, the free-form route generator 108 is able to generate a free-form route that conforms to the user preferences. Additionally, in this way, the generated route is not limited to pre-defined paths, roads, etc. Thus, the free-form route generator 108 is able to generate routes through areas without pre-defined roads, etc. such as through forests, open fields, etc.

Additionally, in some embodiments, the free-form route generator 108 is configured to automatically update the generated route in real-time based on additional data received from one or more sensors 106. In particular, if data from one or more sensors 106 indicates a change in conditions, the free-form route generator 108 updates the generated route. For example, if a user has set a preference for minimum ambient light conditions and, after generating the route, the measured amount of ambient light in an area changes (e.g. a light post in the area goes out resulting in a sensor detecting less ambient light), the free-form route generator 108 updates the free-form route to generate a new free-form route that conforms to the user's preference. Additionally, in another example, data from other user devices 114 may indicate that one or more users are avoiding an area on the generated free-form route. In some such instances, the free-form route generator 108 infers an obstacle in that area and automatically updates the generated free-form route. In other embodiments, the user device 102 prompts the user for input indicating whether the free-form route should be updated based on the additional sensor data.

In some embodiments, the sensor data is received indirectly from the sensors 106, such as over a cellular network. For example, in some embodiments, the data collected from the sensors 106 is stored on a database 110 using a connection via network 104. The user device 102 can then retrieve the data from database 110 via network 104. In other embodiments, data from one or more sensors 106 can be communicated directly to the user device 102. For example, one or more of the sensors 106 can be communicatively coupled with the user device 102 via network 104 and provide the collected data directly to the user device 102 rather than indirectly via the database 110. In other embodiments, as discussed above, one or more of the sensors 106 is communicatively coupled with the user device 102 via a short-range wireless network and communicates the collected data to the user device 102 via the short-range wireless network, such as Bluetooth or Wi-Fi. In particular, in some embodiments, an ad hoc mesh network can be formed using the user device 102 and at least a subset of the other user devices 114. Thus, in such embodiments, the free-form route generator 108 can receive real-time data from one or more sensors 106 even if the user device 102 does not have a connection to the network 104 (e.g. where a mobile device does not have a cellular network connection).

In addition, in some embodiments, the user device 102 includes a global satellite position (GPS) receiver which can be used to determine a location of the user device 102. Thus, the user device can output guidance instructions to a user to aid the user in following the free-form route generated by the free-form route generator 108. In some embodiments, the user device 102 can include other systems for determining location in addition to or in lieu of a GPS receiver. For example, in some embodiments, the user device 102 can be configured to use a dead reckoning technique to calculate location based on data from an inertial measurement unit (IMU) comprised of one or more accelerometers and/or gyroscopes.

Additionally, in some embodiments, the sensors 106 are configured to provide data regarding micro-climates. As used herein, a micro-climate is the climate of a small or restricted area which differs from the climate of the surrounding area or neighboring micro-climates. For example, a geographic area can be defined by a political boundary such as a zip code or city limits. A micro-climate in such an example could a climate of a neighborhood in the city limits which differs from the overall climate of the city. For example, one section of the city could be experiencing rain while another section is experiencing sun or clouds without rain. The embodiments described herein enable the free-form route generator 108 to use data regarding micro-climates to generate the free-form routes.

For example, geographic area 201 is depicted as being divided into four smaller micro-climate regions 203-1 . . . 203-N. It is to be understood that area 201 and regions 203-1 . . . 203-N are depicted as rectangular areas for ease of explanation and that the embodiments described herein are applicable to any shape of a geographic area and/or any shape of micro-climate regions. Additionally, it is to be understood that each micro-climate region need not be the same size and that a geographic area can include more than 4 or fewer than four micro-climate regions. Thus, the use of four micro-climate regions in the example of FIG. 2 and FIG. 3 is for purposes of explanation only.

The sensors 206 are configured to collect data throughout area 201 and to associate the data with locations in the area 201. Thus, the sensors 106 can collect information indicating different weather conditions in micro-climate regions 203-1 . . . 203-N. For example, the data from sensors 206 may indicate that micro-climate region 203-1 is experiencing rain, whereas micro-climate regions 203-3 and 203-N are sunny and micro-climate region 203-2 is cloudy.

The free-form route generator 108 is configured, in some embodiments, to use the micro-climate data in generating the free-form route presented to a user. For example, in some embodiments, the free-form route generator 108 can identify more than one route which satisfies user preferences, such as a preference requiring a minimum level of ambient light. FIG. 3 depicts one example in which free-form route generator 108 identifies a path 305 and a path 307 from point A to point B. Both path 305 and path 307 conform to a user's preference for ambient light. Based on the micro-climate data from sensors 206, the free-form route generator determines that micro-climate region 203-1 is experiencing rain whereas micro-climate region 203-3 is not experiencing rain. Thus, based either on a user preference to avoid rain or a default rule to give more weight to a path that does not go through rainy regions, the free-form route generator selects path 307 for presentation to the user, such as on a display screen of a mobile device (e.g. user device 102).

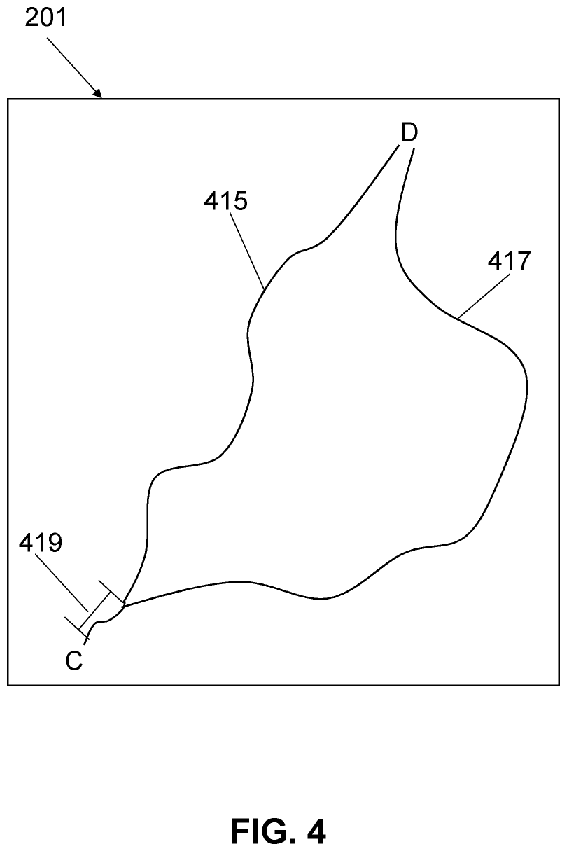

However, it is to be understood that in other embodiments, the free-form route generator 108 does not use micro-climate data to select paths. For example, as shown in FIG. 4, the free-form route generator 108 has identified paths 415 and 417 from point C to point D. The free-form paths 415 and 417 can be identified based on one or more user preferences. In this example, each of the paths 415 and 417 conform to a user's preference for difficulty of terrain (e.g. terrain type, terrain slope, etc.). However, the free-form route generator 108 may select free-form path 415 for presentation to the user as it is shorter than free-form path 417. In some embodiments, the user device 102 can display a plurality of free-form paths that comply with the user's preferences and enable the user to select the free-form path for navigation guidance from an origination point to a destination point. Additionally, it is to be understood that two or more paths may share a common segment, such as common segment 419. Additionally, it is to be understood that one or more portions of a free-form path may include pre-defined road, path, etc., but at least one portion of the free-form path does not include a pre-defined road, path, etc.

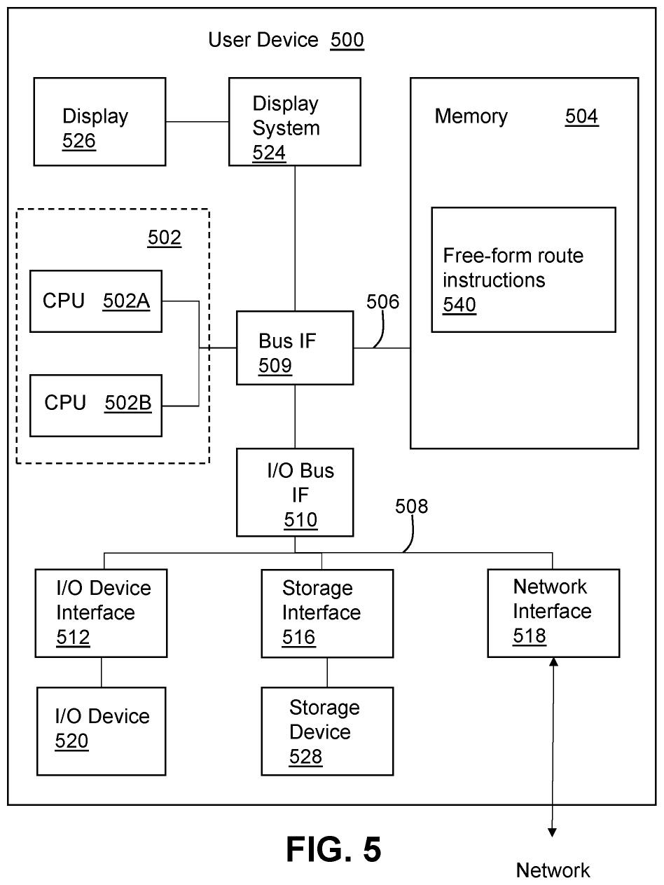

FIG. 5 depicts a high-level block diagram of one embodiment of a user device 500 configured to implement a free-form route generator. Thus, the user device 500 can also be referred to herein as a dynamic route generation system or a free-form route generation system. The components of the user device 500 shown in the example of FIG. 5 include one or more processors 502, a memory 504, a storage interface 516, an Input/Output (“I/O”) device interface 512, and a network interface 518, all of which are communicatively coupled, directly or indirectly, for inter-component communication via a memory bus 506, an I/O bus 508, bus interface unit (“IF”) 509, and an I/O bus interface unit 510.

In the embodiment shown in FIG. 5, the user device 500 also includes one or more general-purpose programmable central processing units (CPUs) 502A and 502B, herein generically referred to as the processor 502. In some embodiments, the user device 500 contains multiple processors. However, in other embodiments, the user device 500 is a single CPU system. Each processor 502 executes instructions stored in the memory 504.

In some embodiments, the memory 504 includes a random-access semiconductor memory, storage device, or storage medium (either volatile or non-volatile) for storing or encoding data and programs. For example, the memory 504 stores free-form route instructions 540. When executed by a processor such as processor 502, the free-form route instructions 540 cause the processor 502 to perform the functions and calculations for generating a dynamic free-form route, as discussed herein.

In some embodiments, the memory 504 represents the entire virtual memory of the user device 500 and may also include the virtual memory of other computer systems coupled directly to the user device 500 or connected via a network. In some embodiments, the memory 504 is a single monolithic entity, but in other embodiments, the memory 504 includes a hierarchy of caches and other memory devices. For example, the memory 504 can exist in multiple levels of caches, and these caches may be further divided by function, so that one cache holds instructions while another holds non-instruction data, which is used by the processor. The memory 504 may be further distributed and associated with different CPUs or sets of CPUs, as is known in any various so-called non-uniform memory access (NUMA) computer architectures, for example.

Hence, although the free-form route instructions 540 are stored on the same memory 504 in the example shown in FIG. 5 for purposes of explanation, it is to be understood that other embodiments can be implemented differently. For example, the free-form route instructions 540 can be distributed across multiple physical media.

Furthermore, in some embodiments, the free-form route instructions 540 are executed by the same processor 502. However, in other embodiments, execution of the free-form route instructions 540 is distributed across multiple processors located in the same or different computer systems. For example, in some such embodiments, at least a portion of the instructions and data structures associated with the free-form route instructions 540 can be on different computer systems and accessed remotely, e.g., via the network interface 518. The user device 500 can use virtual addressing mechanisms that allow the programs of the user device 500 to behave as if it only has access to a large, single storage entity instead of access to multiple, smaller storage entities. Thus, the memory 504 can store all or a portion of the various programs, modules, and data structures for providing free-form route generation as described herein.

The user device 500 in the embodiment shown in FIG. 5 also includes a bus interface unit 509 to handle communications among the processor 502, the memory 504, the display system 524, and the I/O bus interface unit 510. The I/O bus interface unit 510 is coupled with the I/O bus 508 for transferring data to and from the various I/O units. In particular, the I/O bus interface unit 510 can communicate with multiple I/O interface units 512, 516, and 518, which are also known as I/O processors (IOPs) or I/O adapters (IOAs), through the I/O bus 508. The display system 524 includes a display controller, a display memory, or both. The display controller can provide video, audio, or both types of data to a display device 526. The display memory may be a dedicated memory for buffering video data. The display system 524 is coupled with the display device 526, such as a standalone display screen, computer monitor, television, a tablet or handheld device display, or other displayable device. In some embodiments, the display device 526 also includes one or more speakers for rendering audio, such as for announcing navigation directions to aid a user traversing a generated free-form route. Alternatively, one or more speakers for rendering audio may be coupled with an I/O interface unit. In alternate embodiments, one or more functions provided by the display system 524 are on board an integrated circuit that also includes the processor 502. In addition, in some embodiments, one or more of the functions provided by the bus interface unit 509 is on board an integrated circuit that also includes the processor 502.

The I/O interface units support communication with a variety of storage and I/O devices. For example, the I/O device interface unit 512 supports the attachment of one or more user I/O devices 520, which may include user output devices (such as a video display device, speaker, fax machine, printer, and/or television set) and user input devices (such as a keyboard, mouse, keypad, touchpad, trackball, buttons, light pen, or other pointing devices). A user can manipulate the user input devices 520 using a user interface, in order to provide input data and commands to the user I/O device 520 and the user device 500. Additionally, a user can receive output data via the user output devices. For example, a user interface may be presented via the user I/O device 520, such as displayed on a display device, played via a speaker, or printed via a printer. The I/O interface can also enable the attachment of other types of devices, such as an IMU or GPS receiver.

The storage interface 516 supports the attachment of one or more disk drives or direct access storage devices 528 (which are typically rotating magnetic disk drive storage devices, although they could alternatively be other storage devices, including arrays of disk drives configured to appear as a single large storage device to a host computer, or solid-state drives, such as a flash memory). In another embodiment, the storage device 528 is implemented via any type of secondary storage device. The contents of the memory 504, or any portion thereof, may be stored to and retrieved from the storage device 528 as needed. The network interface 518 provides one or more communication paths from the user device 500 to other digital devices and computer systems, such as the sensors, other user devices, and/or database discussed above.

Although the user device 500 shown in FIG. 5 illustrates a particular bus structure providing a direct communication path among the processors 502, the memory 504, the bus interface 509, the display system 524, and the I/O bus interface unit 510, in alternative embodiments the user device 500 includes different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 510 and the I/O bus 508 are shown as single respective units, the user device 500, can include multiple I/O bus interface units 510 and/or multiple I/O buses 508 in other embodiments. While multiple I/O interface units are shown, which separate the I/O bus 508 from various communication paths running to the various I/O devices, in other embodiments, some or all of the I/O devices are connected directly to one or more system I/O buses.

As discussed above, in some embodiments, one or more of the components and data shown in FIG. 5 include instructions or statements that execute on the processor 502 or instructions or statements that are interpreted by instructions or statements that execute the processor 502 to carry out the functions as described herein. In other embodiments, one or more of the components shown in FIG. 5 are implemented in hardware via semiconductor devices, chips, logical gates, circuits, circuit cards, and/or other physical hardware devices in lieu of, or in addition to, a processor-based system. In addition, in other embodiments, some of the components shown in FIG. 5 can be omitted and/or other components can be included.

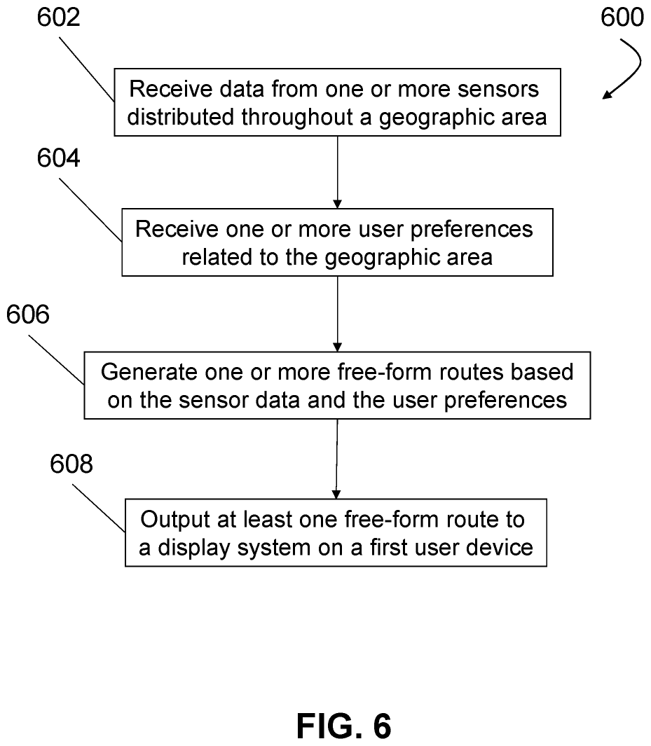

FIG. 6 is a flow chart depicting one embodiment of an example method 600 of generating a free-form route. Method 600 can be implemented by a user device, such as user device 102 or 500 described above. For example, the method 600 can be implemented by a CPU, such as CPU 502 in user device 500, executing instructions, such as free-form route instructions 540. It is to be understood that the order of actions in example method 600 is provided for purposes of explanation and that the method can be performed in a different order in other embodiments. Similarly, it is to be understood that some actions can be omitted or additional actions can be included in other embodiments.

At 602, data from one or more sensors distributed throughout a geographic area are received. For example, the data can be received from at least one of a light sensor, an ultraviolet (UV) sensor, a water sensor, a camera, a heat sensor, a gas sensor, a laser sensor, an ultrasonic sensor, an altimeter, a gyroscope, a barometer, a humidity sensor, or a compass, as discussed above. In addition, as discussed above, one or more of the sensors can be located in another user device via a short-range mesh network. Thus, the user device can form a mesh network with a plurality of other user devices in the geographic area and receive sensor data from the other user devices. In other embodiments, the data from the sensors can be received from a database via a network connection, as discussed above.

At 604, one or more user preferences related to the geographic area are received. At 606, one or more free-form routes from a first location to a second location based on analysis of the received data with respect to the one or more user preferences are generated such that each of the one or more free-form routes complies with the one or more user preferences. As discussed above, each of the one or more free-form routes includes at least a segment which does not follow a pre-defined path. Generating each of the free-form routes can include identifying a plurality of intermediate points in the geographic area which comply with the one or more user preferences and calculating a path from the first location to the second location that traverses the plurality of intermediate points. Thus, by using the sensor data in conjunction with the user preferences, the embodiments described herein enable a computer system to define a free-form route between two locations without the need for using pre-defined paths. This is an improvement over conventional mapping systems which rely on the use of pre-defined paths on maps in order to determine a route between two locations.

The one or more user preferences can include at least one of a terrain preference, an ambient light preference, a UV level preference, a weather preference, or a health preference. The terrain preference can be based on the type of terrain (e.g. rocky, slippery, grass, uneven, etc.), the slope of terrain, distance of terrain (e.g. relative distance of a plurality of free-form routes between a first location and a second location.), etc. The ambient light preference can set a minimum amount of ambient light for points on the free-form route in some embodiments. In other embodiments, the ambient light

P201803861US01 Page 13 of 25 preference can indicate that the free-form path is to use points having the most relative ambient light as compared to other nearby points. In other words, in such embodiments, the ambient light preference can be set to use the relative brightest path. Similarly, other user preferences can set absolute values or relative preferences. For example, the UV level preference can be set to reduce the relative amount of UV level exposure on the free-form path or to select a path for which a maximum UV level is not exceeded. The health preference can relate to the presence of items which may be harmful and/or beneficial for the user. For example, using data from the gas sensor, the user device can generate a free-form path which avoids gases which may have a negative effect on the user or to travel along points which include beneficial gases. Such example can include, but are not limited to, identifying a path with a lower elevation such that more oxygen is present or identifying a path which avoids gases such as high concentrations of sulfur. The weather preference can relate to weather conditions, such as fog, rain, cloud cover, sunshine, etc. Additionally, the weather preferences can be set to the granularity of micro-climates within the geographic area, as discussed above.

Furthermore, it is to be understood that more than one user preference can be used such that the user device is configured to identify points which comply with each of the set user preferences. It is to be understood that, as used herein, complying with the set user preferences can include meeting each of the user preferences individually, in some embodiments. For example, points are selected which meet thresholds set by each of the user preferences individually. In other embodiments, the user preferences can be assigned priorities such that complying with the user preferences can include complying with higher priority user preferences in lieu of lower priority preferences if a point can not be identifies which meets both preferences. For example, a user may indicate a higher priority for ambient light levels and a lower priority for terrain. Thus, if a point can not be identified which meets both preferences, then a point which meets the ambient light levels and has the least deviation from the terrain preference can be selected to comply with the user preferences. In addition, in some embodiments, the user preferences can be applied sequentially in stead of at the same time to generate a free-form route. For example, a plurality of free-form routes can be identified which meet or comply with a user preference for terrain. Then, after identifying the plurality of free-form routes, the user device can filter the plurality of free-form routes based on micro-climate conditions within the geographic area, as discussed above. For example, a free-form route which passes through a micro-climate experiencing rain can be filtered out based on a user preference to avoid rain.

At 606, at least one of the one or more free-form routes is output to a display system on the user device. Outputting the at least one free-form route can include outputting only a selected free-form route in some embodiments. For example, in some embodiments, the user device automatically selects a first free-form route from the one or more generated free-form routes based on user preferences and the sensor data, such as, but not limited to, selecting the first free-form route based on weather data obtained from the one or more sensors indicating different micro-climate conditions within the geographic area. In other embodiments, outputting the at least one free-form route can include outputting a plurality of free-form routes. For example, in some such embodiments, the user device can also output a prompt for a user to provide user input selecting one of the free-form routes.

Outputting the one or more free-form routes can also include, in some embodiments, outputting navigation instructions based on the received location data and the selected first free-form route. For example, location data of the user device can be obtained form a location device, such as a GPS receiver and/or an IMU. The navigation instructions can be output to aid a user in traversing the selected free-form path. For example, the navigation instructions can be output as displayed text and/or audio instructions, in some embodiments. Thus, in addition to identifying a free-form path, the user device can be configured to aid a user in traversing the free-form path. Additionally, the user device can be configured to update the selected free-form route based on additional or subsequent received sensor data, as discussed above.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A computer-implemented method comprising:
receiving data from one or more sensors distributed throughout a geographic area;
receiving one or more user preferences related to the geographic area;
generating one or more free-form routes from a first location to a second location based on analysis of the received data with respect to the one or more user preferences such that each of the one or more free-form routes complies with the one or more user preferences, wherein each of the one or more free-form routes includes at least a segment which does not follow a pre-defined path; and
outputting at least one of the one or more free-form routes to a display system on a first user device.

2. The computer-implemented method of claim 1, wherein receiving data from one or more sensors comprises receiving data from one or more of a light sensor, an ultraviolet (UV) sensor, a water sensor, a camera, a heat sensor, a gas sensor, a laser sensor, an ultrasonic sensor, an altimeter, a gyroscope, a barometer, a humidity sensor, or a compass;
wherein the one or more user preferences include at least one of a terrain preference, an ambient light preference, a UV level preference, a weather preference, or a health preference.

3. The computer-implemented method of claim 2, wherein generating each of the one or more free-form routes includes identifying a plurality of intermediate points in the geographic area which comply with the one or more user preferences and calculating a path from the first location to the second location that traverses the plurality of intermediate points.

4. The computer-implemented method of claim 1 further comprising:
selecting a first free-form route from the one or more free-form routes;
receiving location data of the user device; and
outputting navigation instructions based on the received location data and the selected first free-form route.

5. The computer-implemented method of claim 4, wherein selecting the first free-form route includes selecting the first free-form route based on weather data obtained from the one or more sensors indicating different micro-climate conditions within the geographic area.

6. The computer-implemented method of claim 4, further comprising;
outputting a plurality of free-form routes to the display system of the user device; and
wherein selecting the first free-form route includes selecting the first free-form route based on user input indicating the first free-form route.

7. The computer-implemented method of claim 1, wherein receiving the data from the one or more sensors includes receiving data from at least one sensor in one or more other user devices communicatively coupled with the first user device via a short-range mesh network.

8. A free-form route generation system comprising:
a network interface;
a display system; and
a processor communicatively coupled with the network interface and the display system, wherein the processor is configured to:
receive, via the network interface, data from one or more sensors distributed throughout a geographic area;
generate one or more free-form routes from a first location to a second location based on analysis of the received data with respect to one or more user preferences related to the geographic area such that each of the one or more free-form routes complies with the one or more user preferences, wherein each of the one or more free-form routes includes at least a segment which does not follow a pre-defined path; and
output instructions to the display system to display at least one of the one or more free-form routes.

9. The system of claim 8, wherein the processor is configured to receive data from one or more of a light sensor, an ultraviolet (UV) sensor, a water sensor, a camera, a heat sensor, a gas sensor, a laser sensor, an ultrasonic sensor, an altimeter, a gyroscope, a barometer, a humidity sensor, or a compass;
wherein the one or more user preferences include at least one of a terrain preference, an ambient light preference, a UV level preference, a weather preference, or a health preference.

10. The system of claim 9, wherein the processor is configured to generate each of the one or more free-form routes by identifying a plurality of intermediate points in the geographic area which comply with the one or more user preferences and by calculating a path from the first location to the second location that traverses the plurality of intermediate points.

11. The system of claim 8, wherein the system further comprises at least one of a Global Positioning System (GPS) receiver and an inertial measurement unit (IMU) each configured to provide location data for the system;
wherein the processor is further configured to:
select a first free-form route from the one or more free-form routes;
receive location data of the system from at least one of the GPS receiver and the IMU; and
output navigation instructions based on the received location data and the selected first free-form route.

12. The system of claim 11, wherein the processor is configured to select the first free-form route automatically based on different micro-climate conditions within the geographic area indicated by weather data obtained from the one or more sensors.

13. The system of claim 11, wherein the system further comprises a user input device; and
wherein the processor is further configured to:
output instructions to the display system to display a plurality of free-form routes and a user prompt to select one of the free-form routes; and
receive user input via the user input device indicating the first free-form route.

14. The system of claim 8, wherein the processor is configured to receive data from at least one sensor in one or more other user devices communicatively coupled with the network interface via a short-range mesh network.

15. A computer program product comprising a computer readable storage medium having a computer readable program stored therein, wherein the computer readable program, when executed by a processor, causes the processor to:
receive data from one or more sensors distributed throughout a geographic area;
generate one or more free-form routes from a first location to a second location based on analysis of the received data with respect to one or more user preferences related to the geographic area such that each of the one or more free-form routes complies with the one or more user preferences, wherein each of the one or more free-form routes includes at least a segment which does not follow a pre-defined path; and
output instructions to a display system of a user device to display at least one of the one or more free-form routes.

16. The computer program product of claim 15, wherein the computer readable program is further configured to cause the processor to receive data from one or more of a light sensor, an ultraviolet (UV) sensor, a water sensor, a camera, a heat sensor, a gas sensor, a laser sensor, an ultrasonic sensor, an altimeter, a gyroscope, a barometer, a humidity sensor, or a compass;
wherein the one or more user preferences include at least one of a terrain preference, an ambient light preference, a UV level preference, a weather preference, or a health preference.

17. The computer program product of claim 16, wherein the computer readable program is further configured to cause the processor to generate each of the one or more free-form routes by identifying a plurality of intermediate points in the geographic area which comply with the one or more user preferences and by calculating a path from the first location to the second location that traverses the plurality of intermediate points.

18. The computer program product of claim 15, wherein the computer readable program is further configured to cause the processor to:
select a first free-form route from the one or more free-form routes;
receive location data of the user device; and
output navigation instructions based on the received location data and the selected first free-form route.

19. The computer program product of claim 18, wherein the computer readable program is further configured to cause the processor to select the first free-form route automatically based on different micro-climate conditions within the geographic area indicated by weather data obtained from the one or more sensors.

20. The computer program product of claim 15, wherein the computer readable program is further configured to cause the processor to receive data from at least one sensor in one or more other user devices communicatively coupled with the user device via a short-range mesh network.
